(19) United States
(12) Patent Application Publication
(10) Pub. No.: US 2017/0058828 A1
(43) Pub. Date: Mar. 2, 2017

(54) CASCADE WITH VARYING VANE TRAILING EDGE THICKNESS

(71) Applicant: Rohr, Inc., Chula Vista, CA (US)

(72) Inventor: Landy Dong, La Jolla, CA (US)

(21) Appl. No.: 14/836,696

(22) Filed: Aug. 26, 2015

(51) Int. Cl. F02K 1/70

(52) U.S. Cl. CPC F02K 1/70

(57) ABSTRACT

Aspects of the disclosure are directed to a system associated with a thrust reverser of an aircraft, comprising: a plurality of cascade vanes configured in accordance with a substantially arc-tangent profile, where a leading edge of a first of the cascade vanes has a first width, and a trailing edge of the first of the cascade vanes has a second width that is different from the first width.

### BACKGROUND

Referring to FIG. 1, on an aircraft a typical cascade-style thrust reverser system 100 for a turbofan propulsion system includes a circumferential array of cascades/cascade vanes 104. The cascades 104 are frequently grill- or grate-like structures through which the majority of a fan bypass air 108 from the propulsion system passes through during reverse thrust operation. This bypass air 108 is redirected through the cascades 104 during reverse thrust operation via a deployment of a blocker door 112. During flight when the thrust reverser is stowed, the cascades 104 are concealed/blocked from the external environment via a sleeve 116. During landing/descent of the aircraft when the thrust reverser is deployed, the sleeve 116 is translated aft to expose/unblock the cascades 104. The thrust reverser system 100 provides the exhaust area required by an engine of the aircraft in reverse thrust operation. Additionally, the thrust reverser system 100 is frequently designed to realize a cascade efflux plume vectoring pattern to meet engine re-ingestion and aircraft stability and control requirements.

Each of the cascade vanes 104 includes a leading edge and a trailing edge, such as for example leading edge 114a and trailing edges 114b and 114c. As the nomenclature implies, a leading edge is the portion of a cascade vane 104 that initially interfaces to the bypass flow/air 108, whereas a trailing edge is the portion of the cascade vane 104 that interfaces to the external environment and is the last portion of the cascade vane 104 to interface to the (redirected) bypass air 108.

Conventional design practice has dictated that the cascade vanes 104 have a constant thickness/dimension over the length/span of the cascade 104, in progressing from the leading edge to the trailing edge. Such practice may facilitate ease in manufacture and assembly of the cascade 104. For example, cascades have typically been fabricated using carbon fiber, where sheets of material of a same/common dimension are layered. However, a price is paid in using such design practices in terms of performance/efficiency of the thrust reverser system 100. For example, the reverse thrust that is produced is sub-optimal for a thrust reverser system 100 of a given size/footprint.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system associated with a thrust reverser of an aircraft, comprising: a plurality of cascade vanes configured in accordance with a substantially arc-tangent profile, where a leading edge of a first of the cascade vanes has a first width, and a trailing edge of the first of the cascade vanes has a second width that is different from the first width. In some embodiments, the second width is less than the first width. In some embodiments, the second width is approximately 0.5 times the width of the first width. In some embodiments, the leading edge is associated with an arc-portion of the arc-tangent profile, and the trailing edge is associated with a tangent-portion of the arc-tangent profile. In some embodiments, a second leading edge of a second of the cascade vanes has a third width, and a second trailing edge of the second of the cascade vanes has a fourth width. In some embodiments, the second of the cascade vanes is located aft of the first of the cascade vanes. In some embodiments, the fourth width is different from the second width. In some embodiments, the system further comprises a blocker door configured to redirect a portion of a bypass flow towards the cascade vanes when the thrust reverser is deployed. In some embodiments, the second width is different from the first width in an amount greater than a first threshold such that a rearward acting force imposed on the thrust reverser structure is greater than a second threshold. In some embodiments, the second width is different from the first width in an amount greater than a first threshold, and the first threshold is based on an amount of deviation in an exiting air flow angle that can be tolerated before an impact on at least one of engine efflux re-ingestion or aircraft impingement performance is realized in an amount greater than a second threshold.

### BRIEF DESCRIPTION OF THE DRAWINGS

The present disclosure is illustrated by way of example and not limited in the accompanying figures in which like reference numerals indicate similar elements.

FIG. 1 illustrates a thrust reverser system in a deployed state in accordance with the prior art.

FIG. 2 illustrates a thrust reverser system in a deployed state in accordance with aspects of this disclosure.

FIG. 3 illustrates the thrust reverser system of FIG. 2, with the cascade vanes 204 of FIG. 2 superimposed against conventional cascade vanes.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

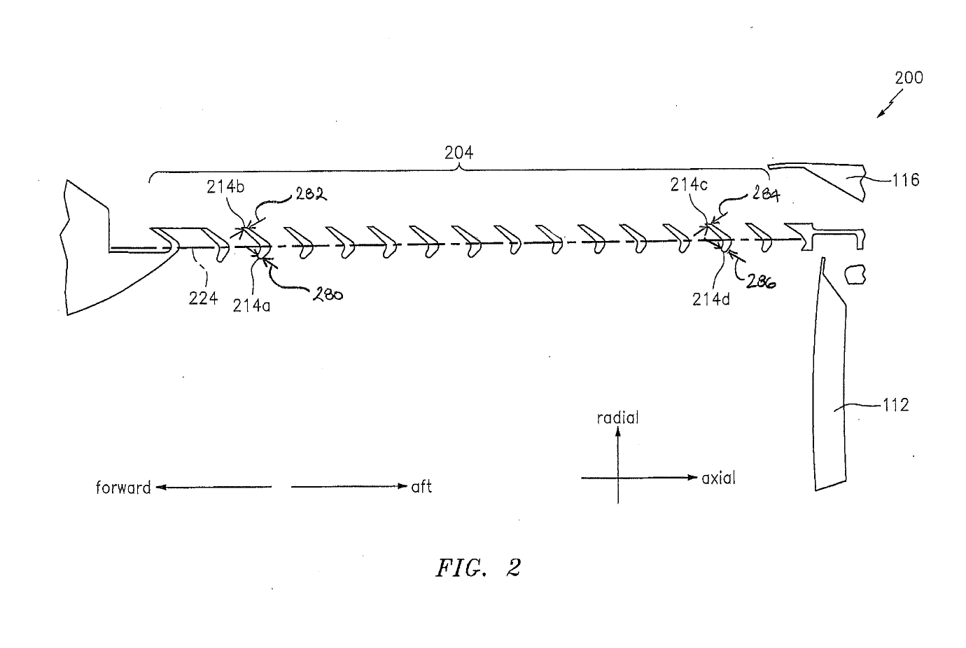

Referring to FIG. 2, a thrust reverser system 200 is shown. The system 200 incorporates some of the components and devices described above in connection with the system 100. As such, a complete re-description is omitted herein for the sake of brevity.

The system 200 may include one or more cascades/cascade vanes 204. The cascade vanes 204 may adhere to one or more shapes/profiles, such as for example a substantially arc-tangent profile. The portion of the cascade vanes 204 below (superimposed) reference line 224 may adhere to the arc-portion of the arc-tangent profile. The portion of the cascade vanes 204 above the reference line 224 may adhere to the tangent-portion of the arc-tangent profile.

Each of the cascade vanes 204 may include a leading edge and a trailing edge, such as for example leading edges 214a and 214d, and trailing edges 214b and 214c. The leading edges may be associated with the arc-portion of the arc-tangent profile. The trailing edges may be associated with the tangent-portion of the art-tangent profile.

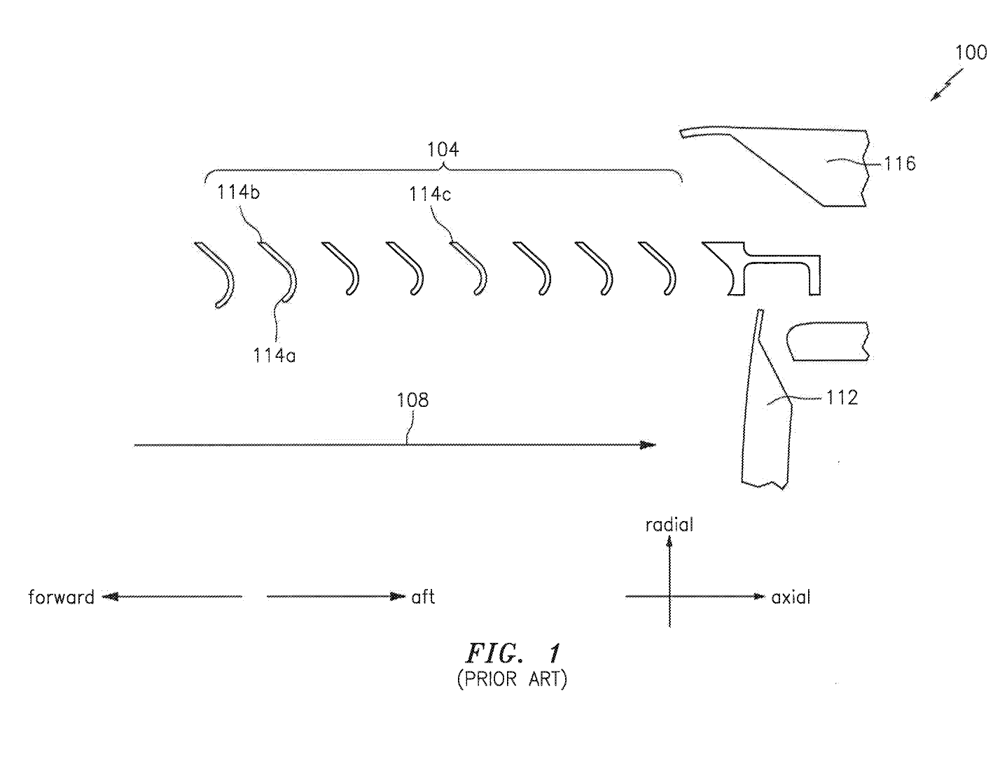

The edges 214a-214d may have associated widths/dimensions. For example, a first of the edges (e.g., leading edge 214a) may have a first width/thickness and a second of the edges (e.g., trailing edge 214b) may have a second width. In this example, the second width may be the same as, or different from, the first width. The second width may be less than (e.g., approximately 0.5 times the width of) the first width. In some embodiments, the first and second widths may be specified in terms of one or more thresholds. As the second width is decreased relative to the first width, the exit flow area of the cascade 204 increases. As the air flow rate is increased, the amount of rearward force acting on the thrust reverser structure is increased. The increased effective flow area and the increased rearward force together improve the reverse thrust performance. However, as the second width is decreased relative to the first width, the deviation in the flow angle of the exiting air flow increases relative to a configuration having a constant vane thickness throughout the chord (e.g., the system 100 of FIG. 1). The choice of the second width may be determined by the amount of deviation in the exiting air flow angle that can be tolerated before a detrimental impact on the engine efflux re-ingestion and/or aircraft impingement performance is realized in an amount greater than a threshold.

In some embodiments, a width associated with a first trailing edge (e.g., trailing edge 214b) may be the same as, or different from, a width associated with a second trailing edge (e.g., trailing edge 214c).

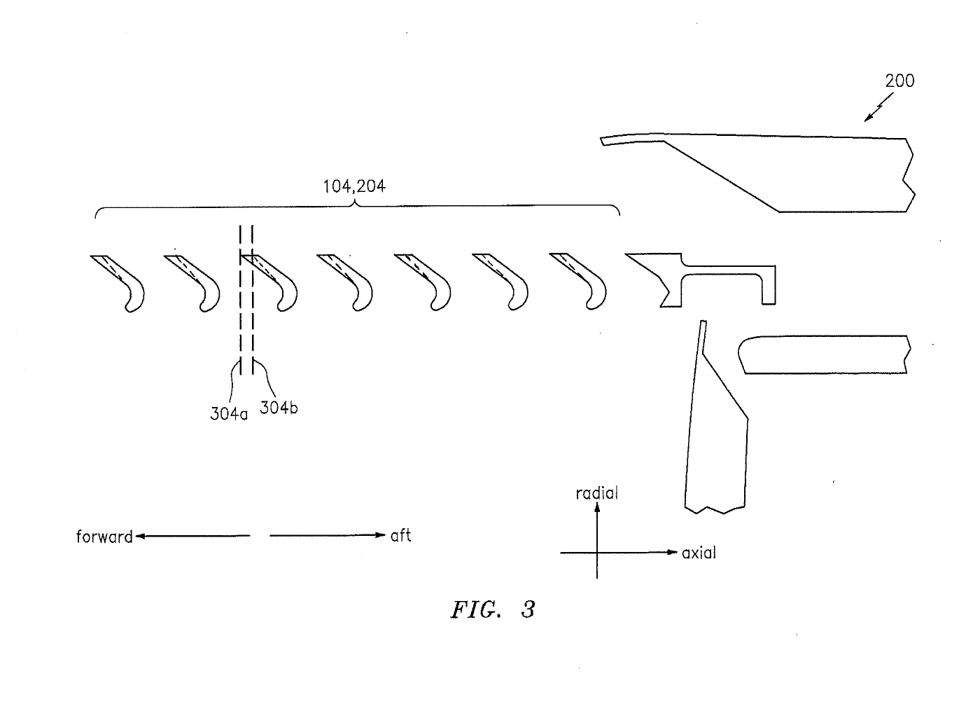

Referring now to FIG. 3, a closer view of the system 200 of FIG. 2 is shown. In particular, in FIG. 3 each of the cascade vanes 204 are superimposed against a conventional cascade vane 104. For example, the portion of the cascade vane 104 between the superimposed reference lines 304a and 304b in FIG. 3 (at the trailing edge of the cascade vane) might not be present in the cascade vane 204.

In view of the examples described above, aspects of the disclosure may provide for a modification (e.g., a reduction) in terms of thicknesses associated with a trailing edge of a cascade vane. Such a modification may result in a change in the effective flow exit area of the thrust reverser cascade array and thereby the rearward acting force on the thrust reverser structure. In this manner, the performance/efficiency of a thrust reverser system may be increased/maximized for a thrust reverser system of a given size/footprint.

The modification of the trailing edge thicknesses may change (e.g., increase) an exit area associated with the cascades/cascade vanes. This change in exit area may result in a change (e.g., an increase) in terms of cascade mass flow. The vector of the exiting cascade flow may remain largely unchanged, despite the modification to the trailing edge thicknesses, such that the engine re-ingestion and stability/control aspects might not be appreciably impacted. Aspects of the disclosure may be used to modify (e.g., increase) the effective flow area of the cascade/cascade vanes.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

1. A system associated with a thrust reverser of an aircraft, comprising:
a plurality of cascade vanes configured in accordance with a substantially arc-tangent profile,
wherein a leading edge of a first of the cascade vanes has a first width,
wherein a trailing edge of the first of the cascade vanes has a second width that is less than the first width,
wherein a second leading edge of a second of the cascade vanes has a third width,
wherein a second trailing edge of the second of the cascade vanes has a fourth width,
wherein the second of the cascade vanes is located aft of the first of the cascade vanes, and
wherein the fourth width is different from the second width.

2. (canceled)

3. The system of claim 1, wherein the second width is approximately 0.5 times the width of the first width.

4. The system of claim 1, wherein the leading edge is associated with an arc-portion of the arc-tangent profile, and wherein the trailing edge is associated with a tangent-portion of the arc-tangent profile.

5. (canceled)

6. (canceled)

7. (canceled)

8. The system of claim 1, further comprising:
a blocker door configured to redirect a portion of a bypass flow towards the cascade vanes when the thrust reverser is deployed.

9. (canceled)

10. (canceled)

11. A system for a thrust reverser of an aircraft, comprising:
a cascade structure comprising a plurality of cascade vanes configured in a grate-like structure;
each of the cascade vanes comprising a cupped profile including an arcuate portion and a tangent portion, wherein the tangent portion is tangent to the arcuate portion; and
each of the cascade vanes comprising a thickness that changes as the respective cascade vane extends, downstream of a minimum flow area location of a vane passage, along the cupped profile;
wherein the cascade vanes comprise a first vane and a second vane located downstream of the first vane, and the thickness of a trailing edge of the first vane is different than the thickness of a trailing edge of the second vane.

12. The system of claim 1, wherein the thickness of the first vane changes as the first vane extends along the tangent portion.
